(19) United States
(12) Patent Application Publication
(10) Pub. No.: US 2026/0185450 A1
(43) Pub. Date: Jul. 2, 2026

(54) ROTOR ELEMENT FOR A TURBINE ENGINE WITH COMPOSITE BLADES LINKED TO A METAL DISK

(71) Applicant: SAFRAN AIRCRAFT ENGINES, Paris (FR)

(72) Inventors: Sadim DIEUDONNE, Moissy-Cramayel (FR); Olivier BAZOT, Moissy-Cramayel (FR)

(73) Assignee: SAFRAN AIRCRAFT ENGINES, Paris (FR)

(21) Appl. No.: 19/129,930

(22) PCT Filed: Nov. 15, 2023
(86) PCT No.: PCT/FR2023/051805

§ 371 Date: May 14, 2025

(30) Foreign Application Priority Data
Nov. 15, 2022 (FR) FR2211859

(51) Int. Cl. F01D 5/28; B64D 27/10; F01D 5/02

(52) U.S. Cl. CPC F01D 5/282; F01D 5/021; B64D 27/10; F05D 2230/237; F05D 2300/603

(57) ABSTRACT

The invention relates to a rotor element (48) for a turbine engine, comprising a metal disk (62) and a plurality of blades (49) mounted on the disk (62). At least one of said blades (49) consists of a hybrid blade (79) made of composite material and comprising a metal root (80) linked to the disk (62).

### FIELD OF THE INVENTION

The present invention relates to the field of turbomachines and more particularly that of rotors for a turbomachine of the type comprising blades made of composite material.

### TECHNICAL BACKGROUND

Conventionally, turbomachine rotors, in particular fan and compressor rotors, are formed of blades mounted around a hub, commonly called a “disk” and generally being metallic. Most often, the blades are themselves also metallic and are attached to the disk by means of a broached fastener, forming a root of the blade, housed in a cell provided on the periphery of the disk.

Various solutions have been proposed with the aim of lightening the turbomachine rotors, in such a way as to improve consumption and to contribute to healthy shaft dynamics.

For compressor rotors, for example, it has been proposed to use integrally bladed rotors (better known by the acronym “IBR” or the name “blisk”) in which the blades are integral with the disk. This solution enables the rotor to be lightened by reducing the number of parts and eliminating the need for sealing systems when using broached fasteners. To this end, the blades are typically machined from the same block of material as the disk, or welded onto the disk.

For fan rotors, it has been proposed to use blades at least partially composed of a composite material structure comprising a fibre reinforcement densified by a polymer matrix, with the blades always being attached to the disk by means of a broached fastener. This solution makes it possible to lighten the rotor by reducing the weight of the blades, since composite blades are lighter than metal blades with equivalent propulsion characteristics.

However, these solutions are not entirely satisfactory. More specifically, single-piece bladed disks remain relatively dense compared to solutions using composite materials, which, in turn, have a complex architecture due to the necessary use of sealing systems.

### DISCLOSURE OF THE INVENTION

One objective of the invention is to further lighten turbomachine rotors. Other objectives are to simplify their architecture and ensure good mechanical strength.

For this purpose, a first aspect of the invention relates to a rotor element for a turbomachine comprising a metal disk and a plurality of blades mounted on the disk, wherein least one of said blades consists of a hybrid blade made of composite material and comprising a metal heel connected to the disk.

According to a particular embodiment of the invention, the rotor element also has one or more of the following features, taken alone or in any technically possible combination:
each of the blades consists of a hybrid blade;
at least one other of the blades consists of a metal blade;
at least one other of the blades consists of a composite blade;
the or each other blade consists of a metal blade;
the or each other blade consists of a composite blade;
the or each hybrid blade is mostly made of composite material;
the heel is connected to the disk by welding or brazing;
the disk has an edge and, for the or each hybrid blade, a connecting surface, arranged on said edge, to which the heel of said hybrid blade is connected;
the connecting surface is substantially planar;
the connecting surface is substantially perpendicular to a radial direction of the disk;
the disk comprises, for the or each hybrid blade, a base projecting radially outwards from the edge, said base having, opposite the edge, a distal end constituting the connecting surface of said hybrid blade;
the base has a peripheral surface bordering the distal end and the hybrid blade is positioned relative to the base such that its intrados, its extrados, its leading edge and its trailing edge are each flush with the peripheral surface of the base;
the edge has a rotationally symmetric shape;
the edge partially delimits an air flow path of the turbomachine;
the rotor element constitutes a compressor-rotor or fan-rotor stage;
the heel has an aerodynamic profile; and
the heel is made of metal and the hybrid blade comprises a distal portion, remote from the disk, at least partially composed of a composite material structure, said distal portion being an extension of the heel at the intrados and at the extrados.

Another object of the invention, according to a second aspect, is a turbomachine comprising a rotor element according to the first aspect.

Yet another object of the invention, according to a third aspect, is an aircraft comprising at least one turbomachine according to the second aspect.

Finally, another object of the invention, according to a fourth aspect, is a method for manufacturing a rotor element according to the first aspect, comprising the following steps:
providing a metal disk,
providing at least one hybrid blade made of composite material and comprising a metal heel, and
connecting the heel of the or each hybrid blade to the disk.

According to particular embodiments of the invention, the manufacturing method also has one or more of the following features, taken alone or in any technically possible combination:
the heel of each hybrid blade is connected to the disk by welding or brazing;
the welding of the heel of each hybrid blade to the disk is produced by friction, for example by linear or orbital friction;
the connection of the heel of each hybrid blade to the disk produces at least one welding bead, the manufacturing method comprising an additional step of machining the welding bead; and
the method comprises an additional step of static balancing of the rotor element, for example by machining a circumferential bead formed in the disk or by adding weights attached to the disk.

### BRIEF DESCRIPTION OF THE FIGURES

Other features and advantages of the invention will appear on reading the description which follows, provided only by way of example and with reference to the attached drawings, in which:

FIG. 1 is a view from above of an aircraft according to an exemplary embodiment of the invention,

FIG. 2 is a longitudinal sectional view of an upper half of a turbomachine of the aircraft of FIG. 1,

FIG. 3 is a three-quarters front perspective view, of a rotor stage of a compressor of the turbomachine of FIG. 2,

FIG. 4 is a three-quarters front perspective view, of a blade of the rotor stage of FIG. 3,

FIG. 5 is a face view of a disk of the rotor stage of FIG. 3,

FIG. 6 is a view of a detail marked VI in FIG. 5,

FIG. 7 is a sectional view of the rotor stage of FIG. 3 along a sectional plane marked VII-VII in FIG. 3,

FIG. 8 is a view of a detail marked VIII in FIG. 7,

FIG. 9 is a diagram illustrating a manufacturing method of a rotor comprising the rotor stage of FIG. 3,

FIG. 10 is a side view of the rotor stage of FIG. 3 during manufacture of a first stage of the method of FIG. 9,

FIG. 11 is a view of a detail marked XI in FIG. 10,

FIG. 12 is a side view of the rotor stage of FIG. 3 during manufacture, at a second stage of the method of FIG. 9, and

FIG. 13 is a view of a detail marked XIII in FIG. 12,

FIG. 14 is a side view of the rotor stage of FIG. 3 during manufacture, at a third stage of the method of FIG. 9,

FIG. 15 is a view of a detail marked XV in FIG. 14,

FIG. 16 is a sectional view of a portion of the blade of FIG. 4 along a plane oriented parallel to an extension axis of said blade and including the bead of the latter, in a first embodiment of the invention,

FIG. 17 is a sectional view of a portion of the blade of FIG. 4 along a plane orthogonal to the bead of said blade, according to the first embodiment of the invention,

FIGS. 18 and 19 are similar views to those of FIGS. 16 and 17 respectively, according to a second embodiment of the invention, and

FIGS. 20 and 21 are similar views to those of FIGS. 16 and 17 respectively, according to a third embodiment of the invention.

### DETAILED DESCRIPTION OF AN EXEMPLARY EMBODIMENT

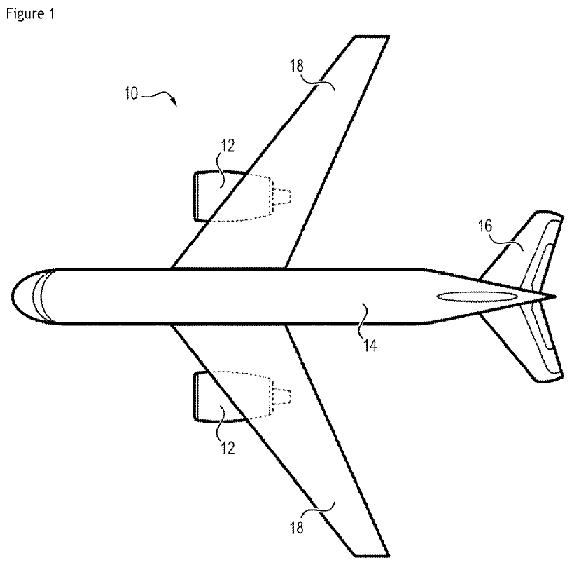

The aircraft 10 shown in FIG. 1 comprises turbomachines 12 to propel it.

In the example shown, the aircraft 10 is an aeroplane. This comprises, in conventional manner, a fuselage 14, a tail assembly 16 and two wings 18. Here, there are two turbomachines 12 each mounted under a respective wing 18. In an alternative (not shown), the turbomachines 12 are disposed along the fuselage 14, for example close to the tail assembly 16. In another alternative (also not shown), the aircraft 10 comprises a single turbomachine 12 or at least three turbomachines 12.

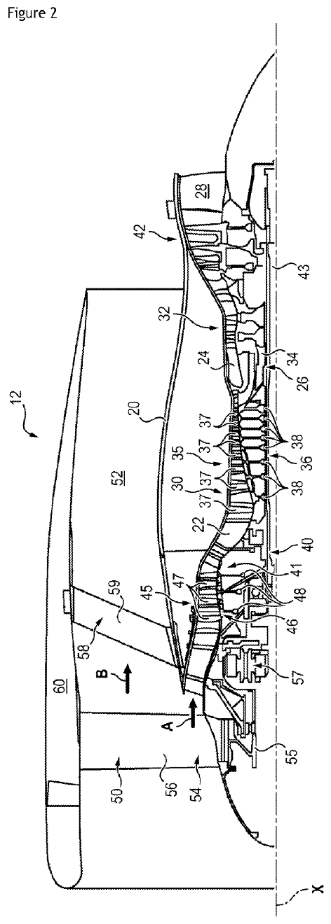

One of the turbomachines 12 is shown in FIG. 2.

As can be seen in this figure, the turbomachine 12 is elongate along a longitudinal axis X. Typically, it has an angular symmetry about said longitudinal axis X, in other words there is at least one angle for which the turbomachine is invariant under rotation about the longitudinal axis X.

Here and hereinafter, the terms “inside” and “outside”, “inner” and “outer”, as well as their variations, extend with reference to the axis X, an element qualified as “inside” or “inner” being oriented towards the axis X, while an “outside” or “outer” element is oriented in the direction opposite to the axis X. The terms “radial” and its variations extend with reference to a direction orthogonal to the axis X.

Conventionally, the turbomachine 12 comprises a nacelle 20, an inner flow path 22 for the circulation of an air flow through the nacelle 20, a combustion chamber 24 housed in the flow path 22, a motor body 26 and an exhaust gas nozzle 28.

Hereinafter, the terms “upstream” and “downstream” extend with reference to a flow direction of the air flow through the flow path 22.

The motor body 26 comprises a compressor 30, a turbine 32 and a drive shaft 34 coupling the turbine 32 to the compressor 30 for driving of the compressor 30 by the turbine 32.

The compressor 30 is disposed upstream of the combustion chamber 24 and feeds the combustion chamber 24 with compressed air. It comprises a stator 35 and a rotor 36. The stator 35 is integral with the nacelle 20. The rotor 36 is capable of being rotated with respect to the stator 35 by means of the drive shaft 34; for this purpose, it is typically fixedly mounted on the drive shaft 34.

The stator 35 comprises at least one, in this case a plurality, of stator stages 37, each formed of blades (not referenced) arranged substantially in the same radial plane. Similarly, the rotor 36 comprises at least one, in this case a plurality, of rotor stages 38, each formed of blades (not referenced) arranged substantially in the same radial plane. There are the same number of stator 37 and rotor 38 stages, and these alternate with one another.

The turbine 32 is disposed downstream of the combustion chamber 24 and receives the exhaust gas leaving the combustion chamber 24.

The longitudinal axis X is the axis of rotation of the drive shaft 34.

The drive shaft 34 is guided in rotation with respect to the nacelle 20 by means of bearings (not shown).

In the example shown, the turbomachine 12 is a multiple-body turbomachine, in particular a double-body turbomachine, comprising a low-pressure body 40 in addition to the engine body 26. The engine body 26 therefore constitutes a high-pressure body, the compressor 30 being a high-pressure compressor, the turbine 32 being a high-pressure turbine and the drive shaft 34 being a high-pressure shaft.

The low-pressure body 40 comprises a low-pressure compressor 41, a low-pressure turbine 42 and a low-pressure shaft 43 coupling the low-pressure turbine 42 to the low-pressure compressor 41, for driving the low-pressure compressor 41 by the low-pressure turbine 42.

The low-pressure compressor 41 is disposed upstream of the high-pressure compressor 30 and feeds the latter with compressed air. It comprises a stator 45 and a rotor 46. The stator 45 is integral with the nacelle 20. The rotor 46 is capable of being rotated with respect to the stator 45 by means of the low-pressure shaft 43; for this purpose, it is typically fixedly mounted on the low-pressure shaft 43.

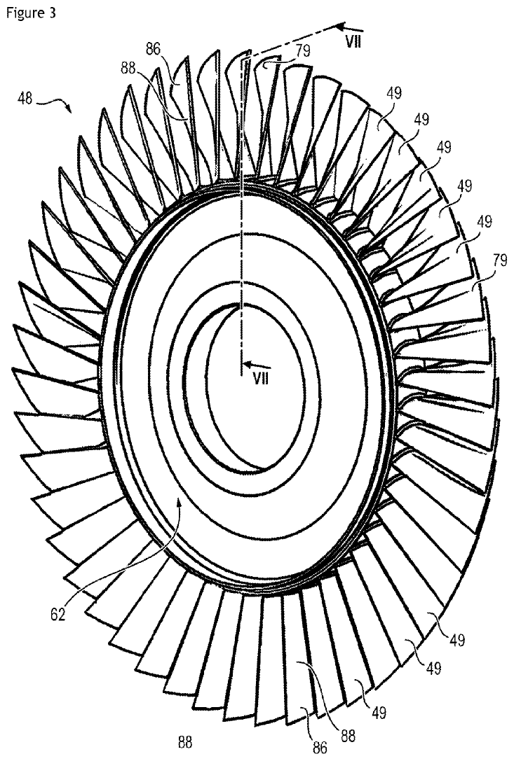

The stator 45 comprises at least one, in this case a plurality, of stator stages 47 each formed of blades (not referenced) arranged substantially in a same radial plane. Similarly, the rotor 46 comprises at least one, in this case a plurality, of rotor stages 48, each formed of blades 49 (FIG. 3) arranged substantially in the same radial plane. There are the same number of stator 47 and rotor 48 stages, and these alternate with one another.

The low-pressure turbine 42 is disposed downstream of the high-pressure turbine 32 and receives the exhaust gas leaving the latter.

The low-pressure shaft 43 is guided in rotation with respect to the nacelle 20 by means of bearings (not shown).

The low-pressure shaft 43 is coaxial with the high-pressure shaft 34. Its axis of rotation is therefore also the longitudinal axis X. In particular, the low-pressure shaft 43 extends inside the high-pressure shaft 34.

Here, the turbomachine 12 also comprises a fan 50 for driving the air flow in an outer circulation flow path 52 surrounding the nacelle 20. Thus a primary air flow A (hot), constituted by the portion of the air flow driven in the inner circulation flow path 22, can be distinguish from a secondary air flow B (cold), constituted by the portion of the air flow driven in the outer circulation flow path 52.

The fan 50 comprises a fan rotor 54. This fan rotor 54 is rotatably mounted relative to the nacelle 20 about the longitudinal axis X. It comprises a disk 55 provided with fan blades 56 extending substantially radially outwards from the disk 55. These blades 56, when they are rotated, drive the air flow in the outer circulation flow path 52.

The fan rotor 54 is rotated by the low-pressure turbine 42, via the low-pressure shaft 43. In the example shown, this driving is achieved by means of a reducer 57, enabling the fan rotor 54 to rotate at a speed less than that of the low-pressure shaft 43. Alternatively (not shown), this driving is direct, in other words the fan rotor 54 is constrained to rotate with the low-pressure shaft 43.

The fan rotor 54 is, in particular, disposed upstream of the inner circulation flow path 22 and likewise drives the air flow in the latter.

In the example shown, the fan 50 likewise comprises a fan stator 58, also called a flow straightener, comprising stationary vanes 59 arranged at the periphery of the nacelle 20, in the outer circulation flow path 52, along a plane orthogonal to the longitudinal axis X. This fan stator 58 is here arranged downstream of the fan rotor 54.

The outer circulation flow path 52 is here defined between the nacelle 20 and a fan casing 60 surrounding the fan 50. The turbomachine 12 typically consists of a turbojet with high bypass ratio, the bypass ratio being defined as the ratio of the flow rate on the secondary flow B (cold) divided by the flow rate of the primary flow A (hot).

Alternatively (not shown), the turbomachine 12 is devoid of a fan casing 60, in other words the outer circulation flow path 52 has no peripheral delimitation. The turbomachine 12 is then constituted by a turbojet with an unducted fan or by a turboprop.

A rotor stage 48 of the low-pressure compressor 41 is shown in more detail in FIG. 3. As can be seen in this figure, the rotor stage 48 comprises, in addition to the blades 49, a metal disk 62 for supporting the blades 49.

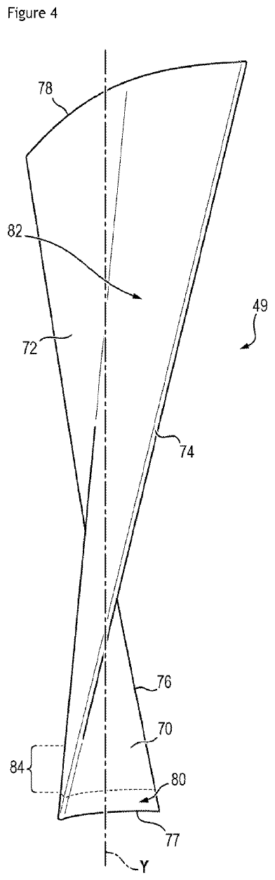

With reference to FIG. 4, each blade 49 is elongate along a substantially radial elongation direction Y, in other words perpendicular to the longitudinal axis X. Hereinafter, “height” designates a distance along the elongation axis Y.

Each blade 49 has an aerodynamic profile shaped so as to generate a lift when it is moved in an air flow. Thus, each blade 49 comprises, as can be seen in FIG. 4, an intrados 70, an extrados 72, a leading edge 74 constituting an upstream edge of the blade 49, a trailing edge 76 constituting a downstream edge of the blade 49, and a bead (not shown), orthogonal to the elongation axis Y, connecting the leading edge 74 to the trailing edge 76.

In the example shown, each blade 49 is twisted around its elongation axis Y, in other words its bead pivots around said elongation axis Y when moved along the elongation axis Y.

Still referring to FIG. 4, each blade 49 also has a proximal end 77 for connecting to the disk 62 and an opposite free distal end 78.

At least one of the blades 49, here a plurality of blades 49, consists of a hybrid blade 79 comprising a proximal portion 80 forming a heel, close to the disk 62, made of metal, and a distal portion 82, remote from the disk 62, at least partially made of a composite material structure (not shown). The proximal portion 80 and the distal portion 82 each have an aerodynamic profile.

The heel 80 delimits the proximal end 77 of the blade 79, which is substantially planar. It typically extends over a height of between 10 and 20% of the height of the blade 79. Alternatively, the heel 80 extends over a height less than 10% of the height of the blade or over a height greater than 20% of the height of the blade.

The metal constituting the heel 80 is, for example, titanium or a titanium alloy.

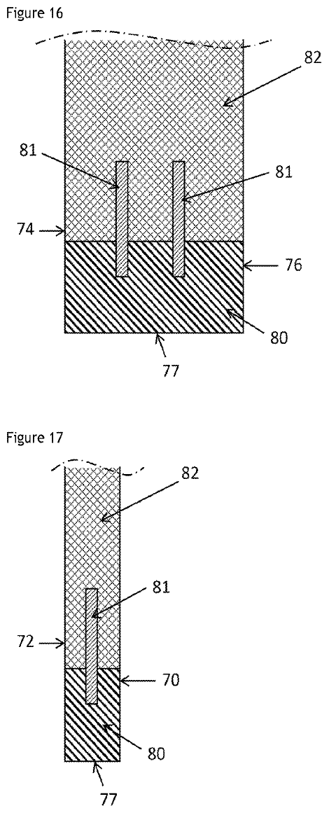

In a first embodiment, illustrated in FIGS. 16 and 17, the heel 80 is attached to the composite material structure by means of at least one pin 81; in this case two pins 81. Each pin 81 is embedded in the composite material structure and shrink fitted in the heel 80. Advantageously, the one or more pins 81 have a geometry that is optimised so as to ensure good strength of the distal portion 82 at the heel 80, despite the centrifugal forces to which the blade 79 is subjected.

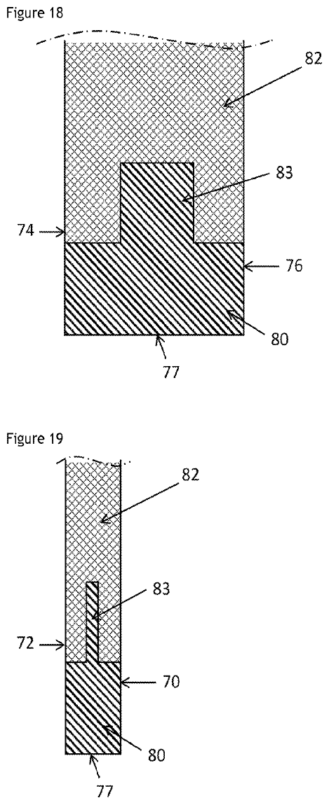

In a second embodiment, in FIGS. 18 and 19, the heel 80 is attached to the composite material structure by means of a metal spar 83, integral with the heel 80 and extending in the composite material. This metal spar 83 is, in this case, elongated along the elongation direction Y. It is typically integral with the heel 80. Advantageously, the metal spar 83 has a geometry that is optimised to ensure good strength of the distal portion 82 at the heel 80, despite the centrifugal forces to which the blade 79 is subjected.

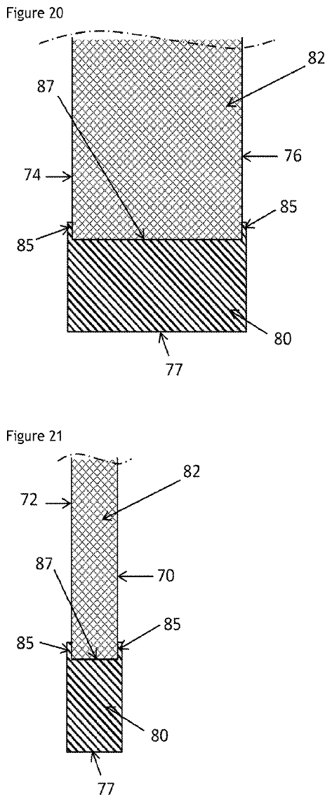

In a third embodiment, illustrated in FIGS. 20 and 21, the heel 80 is attached to the composite material structure by a bathtub-type fastener, in other words by means of ribs 85 integral with the heel 80, between which the composite material structure is embedded. Each rib 85 projects along the elongation direction Y from the face 87 of the heel 80 oriented towards the distal portion 82. Preferably, each rib 85 is positioned, as shown, at the periphery of said face 87 and flush with an edge of said face 87. Here, the ribs 85 together delimit a closed contour in a plane orthogonal to the elongation axis Y. The ribs 85 are typically integral with the heel 80. Advantageously, the ribs 85 have a geometry that is optimised to ensure good strength of the distal portion 82 at the heel 80, despite the centrifugal forces to which the blade 79 is subjected.

Alternatively, the heel 80 is attached to the composite material structure by conventional means known to a person skilled in the art. It is for example screwed to the composite material structure, or introduced directly into a mould in which the fibre reinforcement of the composite material structure is deposited for co-injection during the injection step of the matrix of the composite material structure (typically in the case where the composite material structure is produced by resin transfer moulding).

Returning to FIG. 4, the distal portion 82 extends over the majority of the height of the blade 79, advantageously over at least 80% of the height of the blade 79, for example at least 85%. It extends from the heel 80 to the distal end 78 of the blade 79.

The distal portion 82 is an extension of the heel 80 to the intrados 70 and the extrados 72. In other words, the portions of the intrados 70 and extrados 72 carried by the distal portion 82 are flush with the portions of the intrados 70 and extrados 72 carried by the heel 80, respectively. Thus, there is no sharpness or shoulder at the junction between the distal portion 82 and the heel 80, which avoids disturbing the aerodynamic flow and guarantees good mechanical strength.

The composite material structure extends over the entire height of the distal portion 82. In other words, it extends from the heel 80 to the distal end 78 of the blade 79.

The composite material structure comprises a fibre reinforcement (not shown) and a matrix (not shown) in which the fibre reinforcement is embedded.

The fibre reinforcement is obtained, for example, by three-dimensional weaving. For this purpose, it is typically formed from a single-piece fibre preform with varying thickness comprising warp strands and weft strands, these strands comprising, for example, carbon, glass, basalt, and/or aramid fibres. Said fibre preform is advantageously obtained by three-dimensional or multi-layer weaving, i.e. the warp strands follow sinuous paths in order to interconnect weft strands belonging to different weft strand layers, it being noted that said three-dimensional weaving may include two-dimensional surface weaves. Various three-dimensional weaves may be used, such as interlock, multi-satin, or multiweb weaves, for example as described in particular in document WO 2006/136755. The fibre reinforcement is then embedded in the matrix, for example using the technique known as resin transfer moulding (better known by the acronym RTM).

Alternatively, the composite material structure is obtained by draping various prepreg layers, each comprising the fibre reinforcement and the matrix.

Preferably, the composite material structure constitutes the majority of the blade 79, such that the blade 79 is thus predominantly composed of composite material. The expression “predominantly composed” is understood here and hereinafter in mass proportions, in other words the majority component (here the composite material) constitutes more than 50% by weight of the object (here the blade 79). The composite material structure advantageously constitutes at least 70% by weight of the blade 79.

Alternatively, the composite material structure is a minor component, the blade 79 then being composed predominantly of metal. As a further variant, the blade 79 is composed substantially half of metal and the other half of composite material.

Advantageously, the distal portion 82 is also composed of a metal part, here comprising the spar 83 or the ribs 85, extending the heel 80 inside and/or around the composite material structure. This metal part is preferably integral with the heel 80. It extends over all or part of the height of the distal portion 82.

Preferably, the distal portion 82 then comprises a transition section 84 in contact with the heel 80, wherein the density of the metal part decreases as the distance from the heel 80 increases. This ensures good mechanical strength of the blade 79. This transition section 84 extends over all or part of the distal portion 82.

Returning to FIG. 3, in the example shown, at least one of the blades 49, here two of the blades 49, is constituted by a blade 86 which is not a hybrid blade 79. This blade 86 comprises an aerofoil 88 intended to extend into the air stream, said aerofoil 88 delimiting the distal end 78 of the blade 86 and forming the part of the blade 86 which has an aerodynamic profile. It also comprises a root (not shown) forming the proximal end 77 of the blade 86. This root typically comprises a bulb and a stilt connecting the bulb to the aerofoil 88, the bulb being connected to the stilt by a neck defining a local minimum of the root cross-section.

Said blade 86 is, for example, a metal blade, in other words it is composed solely of metal, or a composite blade, in other words the structure of the blade 86 is composed solely of composite material. For example, the blades 49 comprise a plurality of blades 86, said blades 86 being all metal blades, being all composite blades, or some being composite blades and others being metal blades.

Alternatively (not shown), the blades 49 are all hybrid blades 79.

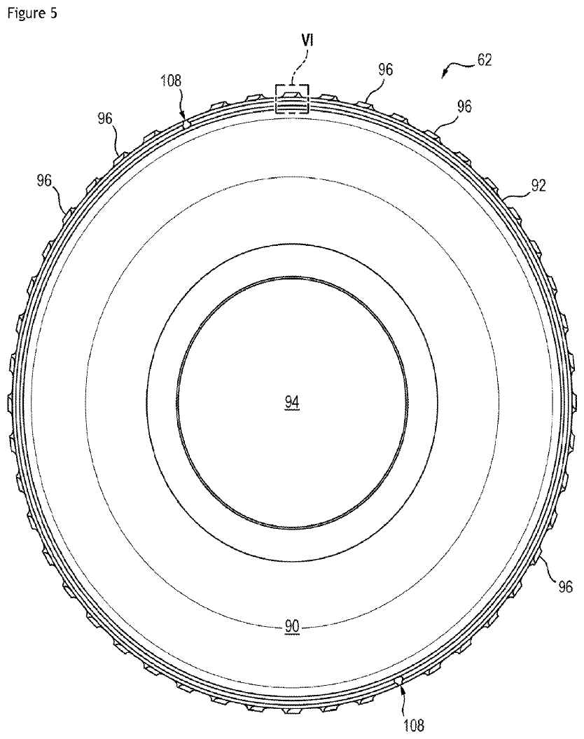

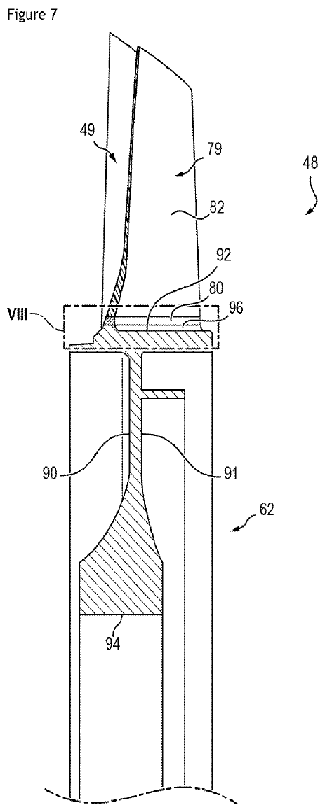

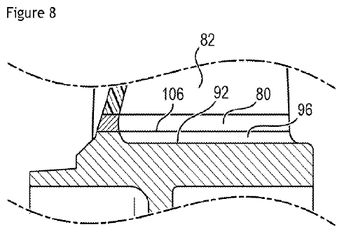

Referring to FIG. 5, the disk 62 comprises a large upstream face 90, a large downstream face 91 (FIG. 7) and, at its external periphery, an edge 92 connecting said large faces 90, 91 to each other. The disk 62 also has a central through orifice 94 opening on each of the large faces 90, 91, such that the disk 62 thus has an annular shape.

The edge 92 delimits an external peripheral edge of the disk 62. It has a circular shape, for example cylindrical or truncated cone-shaped. In particular, the edge 92 partially delimits the inner flow path 22.

The disk 62 also comprises a plurality of bases 96, each projecting radially outwards from the edge 92. Their number is equal to that of the hybrid blades 79. Thus, the disk 62 comprises one base 96 for each hybrid blade 79.

The bases 96 are preferably in one piece with the rest of the disk 62. They are typically machined from the same block of material as the rest of the disk 62.

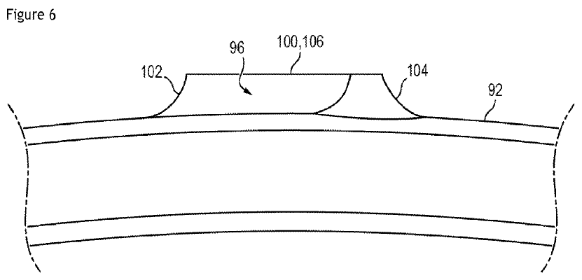

As can be seen in FIG. 6, each base 96 has, opposite the edge 92, a distal end 100. This distal end 100 is substantially planar and substantially perpendicular to a radial direction of the disk 62, in other words there is a radial direction of the disk 62 passing through the distal end 100 and to which the latter is substantially orthogonal.

Each base 96 also has a peripheral surface 102 bordering the distal end 100. This peripheral surface 102 is connected to the edge 92 by a fillet 104. This fillet 104 runs around the base 96. Thus, the transition between the edge 92 and the peripheral surface 102 of the base 96 is gradual, which avoids aerodynamic disturbances.

The distal end 100 constitutes a connecting surface 106 to which the heel 80, more specifically the proximal end 77, of a respective hybrid blade 79 is connected, preferably welded. Thus, the junction between the disk 62 and the hybrid blade 79 is at a distance from the edge 92, which ensures good mechanical strength. Indeed, the main stresses are thus concentrated in the base 96 which, because it is a single piece with the rest of the disk 62, has greater strength.

This connecting surface 106 is of a shape substantially identical to that of the proximal end 77 of the hybrid blade 79 and the hybrid blade 79 is positioned relative to the base 96 such that its intrados 70, its extrados 72, its leading edge 74 and its trailing edge 76 are each flush with the peripheral surface 102 of the base 96. Thus, the junction between the hybrid blade 79 and the disk 62 is devoid of sharpness, which avoids disturbing the aerodynamic flow and guarantees good mechanical strength.

The disk 62 is made of metal. This metal is advantageously of the same nature as the metal constituting the heel 80 of the hybrid blades 79, in other words the majority metallic element constituting each of said metals is identical to the majority metallic element constituting the other metals. Thus, the metal constituting the disk 62 and that constituting the heel 80 of the hybrid blades 79 are, for example, identical metals, or different alloys of the same base metal. This ensures good mechanical strength of the hybrid blades 79 at the disk 62.

In the example shown, the disk 62 also includes cells 108 formed in the edge 92. Their number is equal to that of the blades 86. Thus, the disk 62 comprises one cell 108 for each blade 86.

These cells 108 have a shape substantially complementary to that of the roots of the blades 86 and receive said roots when the blades 86 are attached to the disk 62. The roots of the blades 86 cooperate with said cells 108 to keep the blades 86 attached to the disk 62.

The bases 96 and the cells 108 are regularly distributed along the edge 92, in other words each base 96 or cell 108 is substantially equidistant from each adjacent base 96 or cell 108.

In the alternative where the blades 49 are all hybrid blades 79, the disk 62 does not include any cells 108. The bases 96 are then regularly distributed along the edge 92, in other words each base 96 is substantially equidistant from each adjacent base 96.

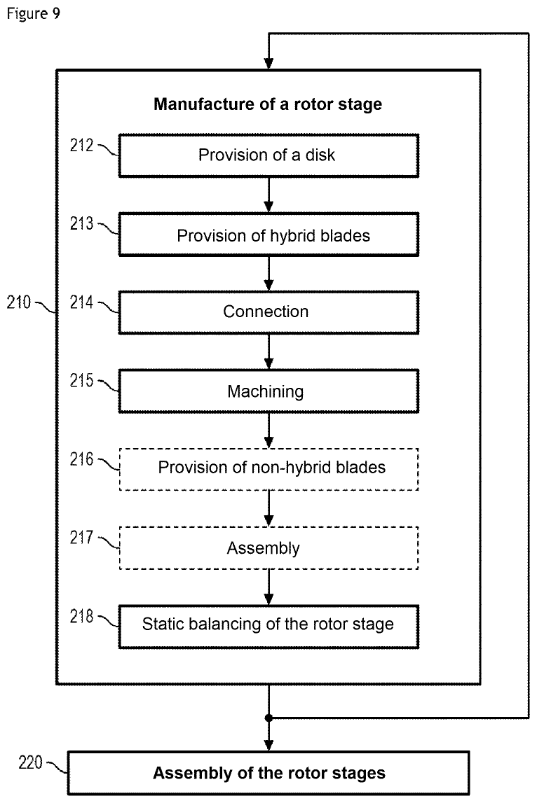

A method 200 for manufacturing the rotor 46 will now be described, with reference to FIGS. 9 to 15.

The method 200 begins with a first step 210 of manufacturing a rotor stage 48 of the rotor 46.

This first step 210 comprises providing 212 the disk 62 and providing 213 the hybrid blades 79. These provision steps 212, 213 are concomitant or, as shown, successive to one another.

Providing 212 the disk 62 typically comprises machining the entire disk 62 from a single block of metal.

Providing 213 the hybrid blades 79 typically comprises machining the heel 80 and the metal parts of the distal portion 82 from a single block of metal, the manufacturing of the composite structure, and the assembly of the heel 80 and the metal parts of the distal portion 82 to the composite structure.

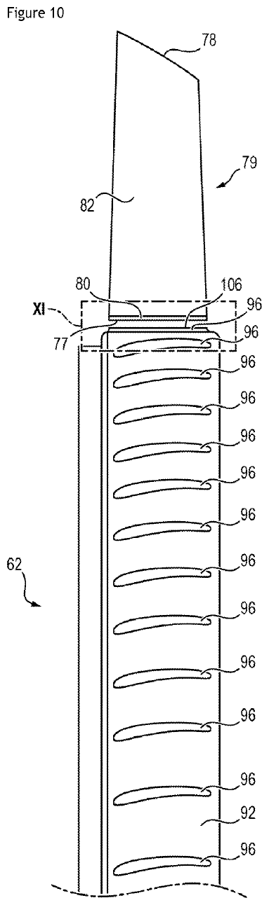

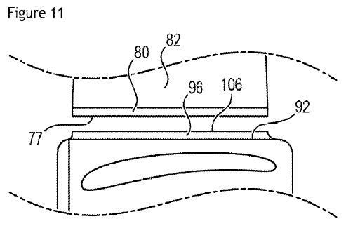

The provision sub-steps 212, 213 are followed by a sub-step 214 of connecting the heel 80 of each hybrid blade 79 to the disk 62. During this sub-step 214, each blade 79 is placed in turn opposite a respective base 96 of the disk 62, as shown in FIGS. 10 and 11, then the proximal end 77 of the blade 79 is brought into contact with the connecting surface 106 delimited by the base 96 and welded to the latter. This welding is advantageously performed by friction, for example by linear or orbital friction. Optionally, the welding uses a filler metal; this filler metal is then of the same nature as the metals making up the blade 79 and the disk 62.

This welding is facilitated by the flatness of the connecting surface 106 and that of the proximal end 77. Indeed, the plane-to-plane contact of the two surfaces to be welded 106, 77 allows friction welding that would be difficult to implement if the surfaces had more complex shapes, for example if one of the two surfaces had a rotational shape like the edge 92. It should be noted that this surface flatness is enabled by the fact that the connecting surface 106 is not directly supported by the edge 92 but by a base 96 projecting from the edge 92.

Alternatively, the proximal end 77 of the blade 79 is not welded but brazed to the connecting surface 106.

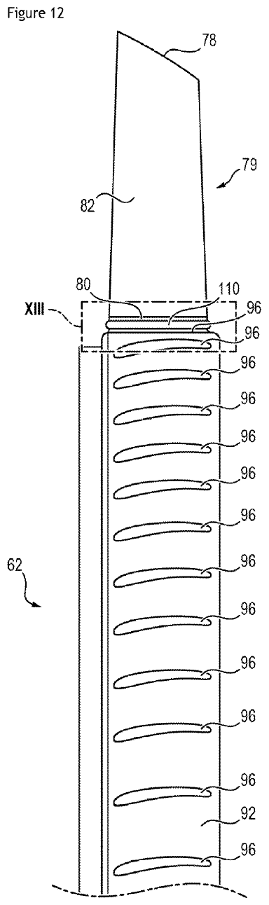

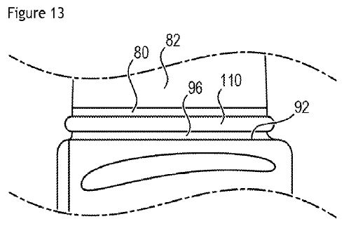

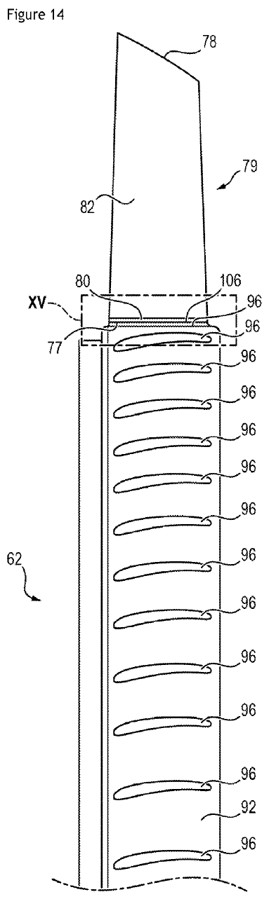

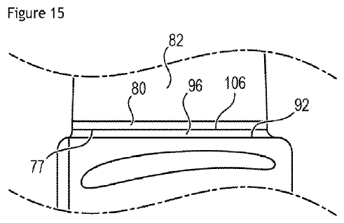

As can be seen in FIGS. 12 and 13, the welding (or brazing) of the heel 80 to the base 96 produces a weld bead 110 at the periphery of the connecting surface 106. This weld bead 110 could disrupt the aerodynamic flow at the root of the blade 79. To remedy this, the connecting sub-step 214 is followed by a sub-step 215 of machining said weld bead 110. During this sub-step 215, the weld bead 110 is machined so as to make the periphery of the junction between the blade 79 and the base 96 smooth and regular, as can be seen in FIGS. 14 and 15.

Machining of the weld bead 110 is facilitated, since it is placed at a distance from the edge 92 by the base 96.

Advantageously, sub-step 215 is implemented in one go, after all the hybrid blades 79 have been welded or brazed to the disk 62. Alternatively, sub-step 215 is implemented in several goes, after each connection of a hybrid blade 79 to the disk 62.

The manufacture 210 of the rotor stage 48 also comprises, where appropriate, providing 216 the non-hybrid blades 86, and the assembly 217 of the latter to the disk 62 by inserting their roots into the cells 108 of the disk 62.

The manufacture 210 of the rotor stage 48 concludes with a sub-step 218 of static balancing of said rotor stage 48, during which material is added and/or removed from the rotor stage 48 so as to ensure its static balancing. This static balancing of the rotor stage 48 is achieved, for example, by machining a circumferential bead (not shown) formed in the disk 62 or by adding weights (not shown) attached to the disk 62.

Step 210 is repeated for each rotor stage 48 of the rotor 46.

These rotor stages 48 are then assembled together during a subsequent assembly step 220. In this way the rotor 46 is obtained.

Through the embodiment described above, it is thus possible to obtain a low-pressure compressor rotor 46 that is lightweight, strong, and simple to produce. In addition, because the hybrid blades 79 comprise a composite material structure, it is easier to adjust their mechanical properties.

It should be noted that, although the embodiment described above relates to a low-pressure compressor rotor, the invention is in no way limited to this single embodiment and applies to any type of turbomachine rotor. In particular, the above description of the rotor stage 48 and the manufacturing method 200 is applicable to a fan rotor such as the rotor 54.

1. A rotor element for a turbomachine comprising a metal disk and a plurality of blades mounted on the disk, wherein at least one of said blades consists of a hybrid blade made of composite material and comprising a metal heel connected to the disk by welding or brazing.

2. The rotor element according to claim 1, wherein the disk has an edge and, for the or each hybrid blade, a connecting surface arranged on said edge, to which the heel of said hybrid blade is connected.

3. The rotor element according to claim 2, wherein the connecting surface is substantially planar.

4. The rotor element according to claim 3, wherein the connecting surface is substantially perpendicular to a radial direction of the disk.

5. The rotor element according to claim 2, wherein the disk comprises, for the or each hybrid blade, a base projecting radially outwards from the edge, said base having, opposite the edge, a distal end constituting the connecting surface for said hybrid blade.

6. The rotor element according to claim 5, wherein the base has a peripheral surface bordering the distal end and the hybrid blade is positioned relative to the base such that its intrados, its extrados, its leading edge and its trailing edge are each flush with the peripheral surface of the base.

7. The rotor element according to claim 2, wherein the edge has a rotationally symmetric shape.

8. The rotor element according to claim 2, wherein the edge partly delimits an air flow path of the turbomachine.

9. The rotor element according to claim 1, constituting a compressor-rotor or fan-rotor stage.

10. The rotor element according to claim 1, wherein the heel has an aerodynamic profile.

11. The rotor element according to claim 1, wherein the heel is made of metal and the hybrid blade comprises a distal portion, remote from the disk, at least partially formed by a composite material structure.

12. The rotor element according to claim 11, wherein said distal portion is an extension of the heel at the intrados and at the extrados.

13. The rotor element according to claim 11, wherein the heel is attached to the composite material structure by means of at least one pin embedded in the composite material structure and shrink fitted in the heel.

14. The rotor element according to claim 11, wherein the heel is attached to the composite material structure by means of a metal spar, integral with the heel and extending in the composite material.

15. The rotor element according to claim 11, wherein the heel is attached to the composite material structure by a bathtub-type fastener.

16. A turbomachine comprising the rotor element according to claim 1.

17. An aircraft comprising the turbomachine according to claim 16.

18. A method for manufacturing the rotor element according claim 1, comprising the following steps:
providing a metal disk,
providing at least one hybrid blade made of composite material and comprising a metal heel, and
connecting the heel of the or each hybrid blade to the disk, said connection being produced by welding or brazing.

19. The manufacturing method according to claim 18, comprising an additional step of static balancing of the rotor element.

20. The manufacturing method according to claim 19, wherein static balancing of the rotor element is achieved by machining a circumferential bead formed in the disk or by adding weights attached to the disk.
